(19) United States
(12) Patent Application Publication
(10) Pub. No.: US 2011/0019496 A1
(43) Pub. Date: Jan. 27, 2011

(54) Emulsification equipment

(76) Inventors: Chang-Wei Hsieh, Taichung City (TW); Man-Hua Liao, Wufong Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,716

(22) Filed: Jul. 21, 2009

(51) Int. Cl. B01F 15/06; B01F 11/02

(52) U.S. Cl. 366/111

(57) ABSTRACT

An emulsification equipment is revealed. The emulsification equipment includes an atmospheric pressure container, a stirring unit arranged over the atmospheric pressure container, a temperature control unit disposed outside the atmospheric pressure container, and an ultrasonic vibrating unit set on the bottom of the atmospheric pressure container. Thereby, through the ultrasonic vibration energy generated by the ultrasonic vibrating unit being transferred to liquid, together with stirring of the stirring unit as well as temperature control by the temperature control unit, an emulsion formed by the emulsification equipment is with better refinement and stability.

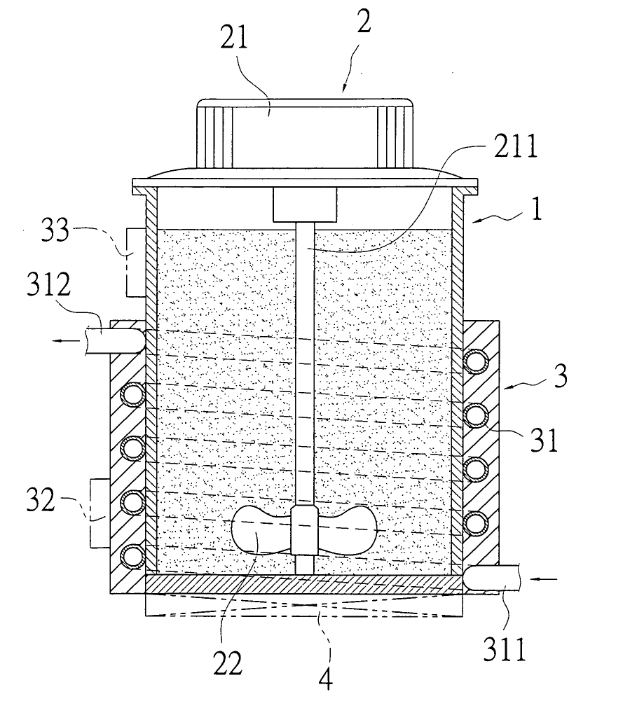

### BACKGROUND OF THE INVENTION

1. Fields of the Invention

The present invention relates to an emulsification equipment, especially to an emulsification equipment that reduces equipment cost and provides an emulsion with better refinement and higher stability.

2. Descriptions of Related Art

The emulsion technology has been developed for over hundred years and has been applied to various fields in our daily lives and industrial production such as food, dairy industry, pesticides, detergents, coatings, neat cutting oil, and drilling fluid. In cosmetic industry, a plurality of raw materials and functional components with limited applications is added into cosmetics (cosmeceuticals) by using emulsions as carriers so as to improve the cosmetic quality without negative effects on its stability. Thus emulsification is also a common technology used in cosmetic processing.

Due to easy applications and excellent product quality of emulsion, the broader application fields accelerate the development of emulsion preparation techniques. The emulsion preparation techniques are divided into two groups: chemical emulsification and mechanical dispersion.

The chemical emulsification forms an emulsion by adding different surfactant solutions. The mechanical dispersion is the most common way used in the emulsification. One liquid (the dispersed phase) is dispersed into the other liquid (the continuous phase) under vigorous stirring. Or an interface between two immiscible liquids is destroyed and broken to form an emulsion. An emulsion is a mixture of two or more unblendable liquids. One liquid forms a continuous phase in which the other liquid (the dispersed phase) is dispersed in the form of small drops. Both emulsion mixers and emulsifying dispersers can generate strong hydrodynamic force and shear force. The mechanical dispersion force breaks the oil drop into micron-size droplets. Yet the dispersed droplets may aggregate again quickly. Thus a suitable emulsifier is required for a stable emulsion.

Conventional common emulsification equipments in current markets could be an atmospheric-pressure homogenizer, a vacuum homogenizer, a high-pressure homogenizer, an ultrasonic emulsification equipment and so on. Users usually select the emulsification equipment according to following principles: (1) Effect of emulsion on production should satisfy requirements for processes. (2) The emulsion equipment is with low power consumption. (3) The investment cost of the equipment must be reasonable.

In an ultrasonic emulsification system, high frequency voltage signals are generated by circuits. Then through a transducer, electric energy is converted into mechanical energy. Finally, the two immiscible liquids are shaken together to form an emulsion. Ultrasound-assisted emulsification was first reported by Wood and Loomis in 1927 (Wood et al., 1927). Then a plurality of studies uses various ultrasonic equipments to prepare emulsions. Recently, a plurality of papers related to ultrasonic emulsification equipments show that different frequency ranges are used. The different operation frequencies are applied depending on different raw materials. The frequency ranges in the studies range from 20 kHz to 10 MHz. How the ultrasonic emulsification equipments work is divided into three groups: mechanical effect, convective transport or streaming and cavitation effect.

Mechanical effect: Ultrasonic wave is a wave pattern consisting of condensations and rarefactions that cause overpressure and negative pressure in liquid. The overpressure leads to compression of liquid molecules while the negative pressure causes the liquid molecules to swell. When the pressure is larger than hydrostatic pressure, the liquid molecules are distorted and dispersed to form bubbles or cavities. Thus water molecules surrounding the cavities move to the cavities and collide to generate a large force that pushes water molecular back and forms shock waves. The energy is released and transferred to the liquid so as to form mechanical stirring effect and achieve emulsification. The ultrasonic device spins over 20000 revolutions per second for transferring energy so as to induce high speed vibration of medicines, mediums, and emulsions. By changing particle structure in the emulsion, the drug penetration through the skin is improved.

Convective transport or streaming: Due to the action of ultrasonic vibrations, bubbles in the samples vibrates vigorously so as to induction rotation of surrounding particles and liquid circulation. This is beneficial to convection and dispersion of the sample.

Cavitation effect: The ultrasound creates an effect like internal explosions in liquid. The acoustic frequency provides the thorough stirring of the liquid by strong chemical and physical reactions. This phenomenon is called cavitation effect that is resulted from formation and collapse of numerous bubbles in the liquid. Such changes affect the emulsification and helps air discharge that replaces vacuum processing.

Although the high-pressure or vacuum emulsification system available now has good emulsifying effect, it has shortcomings of high cost and high energy consumption. Moreover, the use of pressure equipments causes higher risk in the operation of the equipment. As to general stirring apparatus, they are with limited homogenization effect. Furthermore, once the process is without vacuum, the oil is easy to be oxidized and the product quality is reduced. In addition, different surfactant solutions used in the chemical emulsification are formed by chemical compound and are not good for customers.

Thus there is a need to develop an emulsification equipment with high efficiency, lower cost and low power consumption that generates high-quality emulsion.

### SUMMARY OF THE INVENTION

Therefore it is a primary object of the present invention to provide an emulsification equipment that reduces equipment cost and provides an emulsion with better refinement and higher stability.

In order to achieve above objects, an emulsification equipment of the present invention includes an atmospheric pressure container, a stirring unit disposed over the atmospheric pressure container, a temperature control unit arranged outside the atmospheric pressure container, and an ultrasonic vibrating unit set on the bottom of the atmospheric pressure container. Thus through the ultrasonic vibration energy generated by the ultrasonic vibrating unit being transferred to liquid, together with stirring of the stirring unit and temperature control by the temperature control unit, an emulsion formed by the emulsification equipment has better refinement and stability.

The stirring unit consists of an inverter motor and stirring blades disposed on an output shaft of the inverter motor so as to adjust stirring speed according to different types of emulsification processes.

The temperature control unit includes a discharge pipe that consists of a water inlet and a water outlet for hot water supply and discharge. By the circulation of hot water, the atmospheric pressure container is heated and the emulsification is promoted.

The temperature control unit further includes a temperature controller for water for control of hot water temperature. The temperature control unit further includes emulsification temperature controller for monitoring temperature inside the atmospheric pressure container and for feedback control of heating temperature of the hot water in the discharge pipe so as to avoid inactivation of active components in emulsions resulted from high temperature.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein The FIGURE is a schematic drawing showing structure of an emulsification equipment of an embodiment according to the present invention.

### DETAILED DESCRIPTION OF THE PREFERRED EMBODIMENT

Refer to the FIGURE an emulsification equipment of the present invention consists of an atmospheric pressure container (1), a stirring unit (2) disposed over the atmospheric pressure container (1), a temperature control unit (3) arranged outside the atmospheric pressure container (1), and an ultrasonic vibrating unit (4) installed on the bottom of the atmospheric pressure container (1). Thereby, through the ultrasonic vibration energy generated by the ultrasonic vibrating unit (4) being transferred to liquid filled in the atmospheric pressure container (1), together with stirring of the stirring unit (2) and temperature control by the temperature control unit (3), an emulsion with better refinement and stability is obtained.

The stirring unit (2) is formed by an inverter motor (21) and stirring blades (22) disposed on an output shaft (211) of the inverter motor (21). The inverter motor (21) provides power to the stirring blades (22). The inverter motor (21) is used to adjust the stirring speed according to phase change of the emulsions because different stirring speeds are applied to different emulsification processes.

The temperature control unit (3) includes a discharge pipe (31) that is disposed around and outside the atmospheric pressure container (1). The discharge pipe (31) consists of a water inlet (311) and a water outlet (312) for hot water supply and discharge. By the circulation of hot water, the atmospheric pressure container (1) is heated and this is beneficial to the emulsification processes. The temperature control unit (3) further includes a temperature controller for water (32) arranged at the discharge pipe (31) so as to monitor temperature of hot water inside the discharge pipe (31). Moreover, the temperature control unit (3) includes an emulsification temperature controller (33) for monitoring temperature inside the atmospheric pressure container (1) and for feedback control of heating temperature of the hot water in the discharge pipe (31) so as to avoid inactivation of active components in emulsions caused by high temperature.

In accordance with above embodiments, it is learned that the present invention at least has following advantages:
1. The equipment cost of the present invention is lower than that of vacuum emulsification while both are with similar emulsifying effect. Thus the balance among the lower cost, the better refinement and higher stability of the emulsification equipment is achieved.
2. In the emulsification equipment of the present invention, the ultrasonic vibration energy generated by the ultrasonic vibrating unit is transferred to the liquid in the atmospheric pressure container while the stirring unit provides optimal stirring speed according to the emulsification condition and the temperature control unit adjusts water heating temperature as well as temperature during emulsification processes. Thus emulsions with better refinement and stability are obtained.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An emulsification equipment comprising:
an atmospheric pressure container,
a stirring unit disposed over the atmospheric pressure container,
a temperature control unit arranged outside the atmospheric pressure container, and
an ultrasonic vibrating unit installed under the atmospheric pressure container.

2. The device as claimed in claim 1, wherein the stirring unit includes an inverter motor and stirring blades disposed on an output shaft of the inverter motor.

3. The device as claimed in claim 2, wherein the temperature control unit includes a discharge pipe that is disposed with a water inlet and a water outlet for hot water supply and discharge.

4. The device as claimed in claim 3, wherein the temperature control unit further includes a temperature controller for water that is arranged at the discharge pipe.

5. The device as claimed in claim 4, wherein the temperature control unit further includes an emulsification temperature controller disposed on the atmospheric pressure container for feedback control of heating temperature of the hot water in the discharge pipe.

6. The device as claimed in claim 1, wherein the temperature control unit includes a discharge pipe that is disposed with a water inlet and a water outlet for hot water supply and discharge.

7. The device as claimed in claim 6, wherein the temperature control unit further includes a temperature controller for water that is arranged at the discharge pipe.

8. The device as claimed in claim 7, wherein the temperature control unit further includes an emulsification temperature controller disposed on the atmospheric pressure container for feedback control of heating temperature of the hot water in the discharge pipe.
